(19) United States
(12) Patent Application Publication
(10) Pub. No.: US 2005/0147259 A1
(43) Pub. Date: Jul. 7, 2005

(54) Bull cup

(76) Inventors: Massai Z. Dorsey, Beverly Hills, CA (US); James C. Dorsey, Beverly Hills, CA (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 10/749,393

(22) Filed: Jan. 2, 2004

(51) Int. Cl. H04R 27/04; G10K 11/00; B65D 3/00

(52) U.S. Cl. 381/75; 181/179; 229/400

(57) ABSTRACT

The present invention pertains to a drinking cup assembly, which may be converted into a bullhorn for amplifying the human speaking voice.

### FIELD OF THE INVENTION

Beverage dispenser cup, can be converted into a megaphone.

### BACKGROUND AND SUMMERY OF THE INVENTION

At most sporting events beverages are served or dispensed in paper or plastic cup called a sports drink cup. Usually 20 ounces or more.

These sports cups with a slight design change can still be used as a drink dispenser cup, but can also be converted into a megaphone by the removal of the bottom of the dispenser cup. This can be accomplished by pulling out the bottom of the dispenser cup with a string properly embedded in the bottom of the dispenser cup or peeling out the bottom by properly designing the dispenser cup bottom to be removed.

Though inventor specifies the dimensions of this sports cup to be 2½ inches at the bottom and 4¼ inches at the top by 7 inches tall, this dispenser cup can be designed by the use of any practical top, bottom or length configuration deemed suitable.

### BRIEF DESCRIPTION OF THE DRAWINGS

FIG. 1 is a Top View of the dispenser cup assembled.

FIG. 2 is a Top Isometric Left Hand View of dispenser cup 1, sleeve 2 and handles folded out to form handle.

FIG. 3 is a Rear View showing dispenser cup 1, sleeve 2 and handles 3 in unfolded mode.

FIG. 4 is a Left Hand View of dispenser cup 1, sleeve 2 and handles 3 folded out.

FIG. 5 is a view of the Bottom of the dispenser cup 1, sleeve 2, handles 3 shown formed against the dispenser cup 1, bottom tear out string 4 and bottom 5, still in place.

FIG. 6 is a Top Isometric Left Hand View of dispenser cup 1, sleeve 2 and handles 3, shown still formed around the dispenser cup 1, as they will appear after it had been formed by the assembly machine.

FIG. 7 is a Rear View of the dispenser cup 1, sleeve 2 and handles 3 formed against the dispenser cup 1, as they will appear after being formed by the assembly machine.

FIG. 8 is a Left Hand View of the dispenser cup 1, sleeve 2 and handle 3 as it they appear after being formed by the assembly machine.

FIG. 9 is a Bottom View of the dispenser cup 1, sleeve 2 and handles 3 as they will appear still formed around the dispenser cup 1, string 4 still attached to bottom 5 as it will appear after being formed by the assembly machine.

FIG. 10 is a Bottom Isometric Left Hand View as the dispenser cup 1, sleeve 2, handles 3, still formed around dispenser cup 1, and string 4, attached to bottom 5, as it will appear after being formed by the assembly machine. String 4, shown removed from bottom 5, and string 4, is still attached.

### DESCRIPTION OF A PREFERRED EMBODIMENT OF THE INVENTION

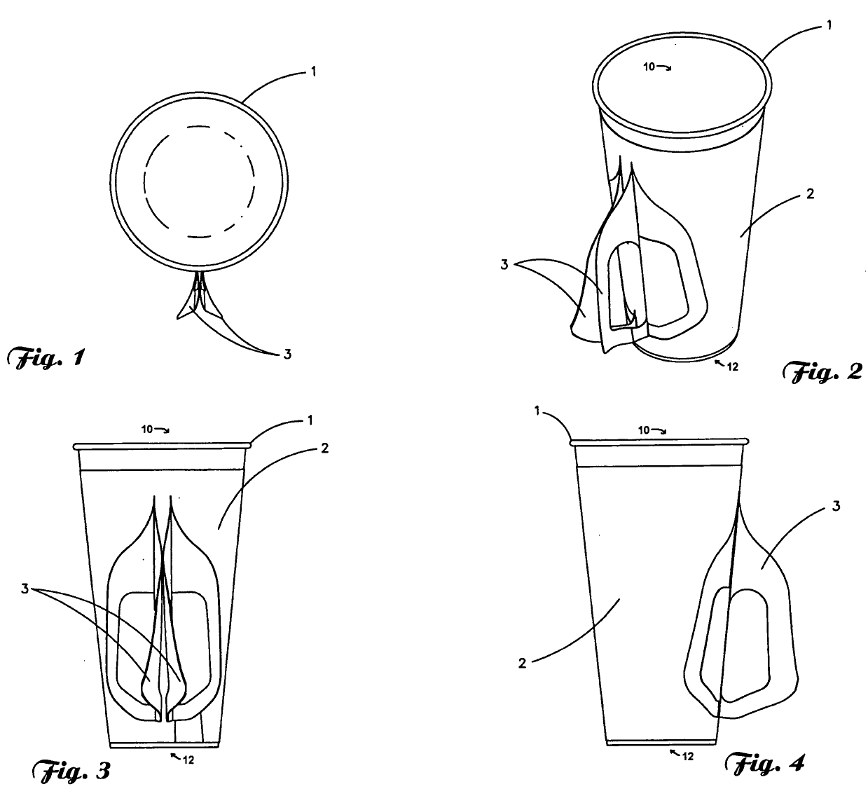

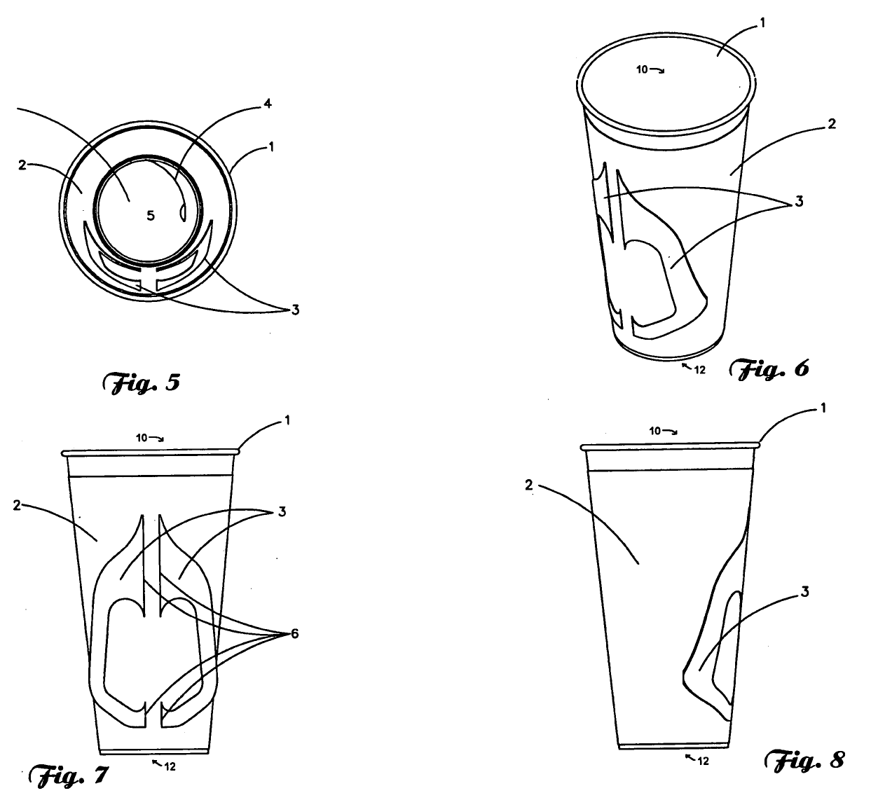

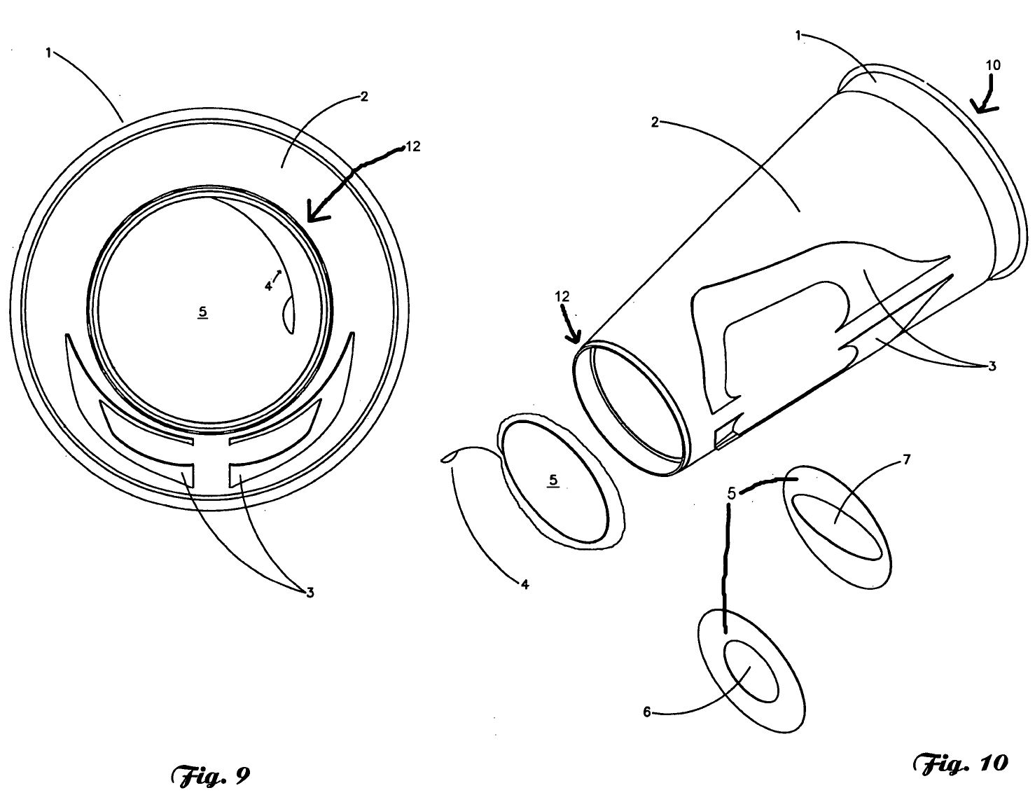

Referring TO FIGS. 1 through 10, there is shown a drink dispenser cup assembly embodying features of the invention. Some variations in structural detail and structural arrangement can be employed while still practicing the invention. The drawings are illustrative of the inventive concept.

The illustrated drink dispenser cup assembly includes a dispenser cup 1 and a outer sleeve 2, designed and manufactured in such a faction that handles 3, shall be formed as shown in FIG. 7 on sheet 2/3. The handles 3, at this stage does not form a handle that can be grasped at this time. When the overall assembly shall have the bottom 5, removed by the string 4, opening up the bottom end of the dispenser cup and the handles 3 shall be folded down so that assembly can be used as a megaphone. BULL CUP. FIG. 2 and FIG. 4 of sheet 1/3 and FIG. 10 of sheet 3/3 showing bottom 5, removed by string 4, in FIG. 10 of sheet 3/3.

Other possible cut outs 6 and 7, in the bottom of the BULL CUP as shown on bottom 5, cut out 6, of some specified diameter, or oval cut out 7, in some geometric configuration that might promote better sound dispersion.

The sleeve allows the dispenser cup 1, to maintain its fluid and sound integrity when the dispenser cup assembly is used as a megaphone that inventor referrers to a BULL CUP.

A crease 6, at the 4(four) locations on 2, of FIG. 7 sheet 2/3 will facilitate the forming of handle 3.

1. An apparatus useful as a beverage cup under one adaptation and as a bullhorn under the second adaptation, the apparatus comprising:
a hollow body portion having a enclosed open first end, a narrow second end and an removable base portion along said second end for maintaining the apparatus in an upright position, said second end including a removable base and said first end including an enlarged opening defined by a pouring lip:
a detachable base to said body portion along the second end to seal the base and where by upon detaching the base from the body portion the apparatus can be converted from a beverage cup to a bull cup.

2. The apparatus of claim 1, further comprising handle means extending from said body portion for grasping the apparatus.

3. The apparatus of claim 2, further comprising handle means is an elongated U shaped wherein said handle means extends from said body portion of apparatus.

4. The apparatus of claim 1, wherein the second end of said body portion and beneath said base includes pull string means for selective removal of said base.

5. The apparatus of claim 1, wherein said body portion is slightly conical which allows for enhanced voice amplification.

6. An apparatus useful as a beverage container under one adaptation and as a bullhorn under another adaptation, the apparatus comprising:
a slightly conical hollow body portion having an enlarged open first end, an opening defined by a pouring lip;
a narrow closed second end serving as base portion along second end for maintaining the apparatus in an upright position;
a detachable base portion; and whereby the apparatus is capable of being converted into a bullhorn by detaching said base.

7. The apparatus of claim 6, further comprising handle means extending from said body portion for grasping the apparatus.

8. The apparatus of claim 7, wherein said handle means extend from outside of said body portion.

9. The apparatus of claim 8, wherein said handle means is an elongated U shaped.

10. The apparatus of claim 6, wherein said first end of said base includes a pull string means for selective removal of said base.
